(19) United States
(12) Patent Application Publication
(10) Pub. No.: US 2026/0126789 A1
(43) Pub. Date: May 7, 2026

(54) SYSTEMS, APPARATUSES, METHODS, AND COMPUTER PROGRAM PRODUCTS FOR INTELLIGENT FAULT DETECTION AND MITIGATION

(71) Applicant: Honeywell International Inc., Charlotte, NC (US)

(72) Inventors: Junda Zhu, Atlanta, GA (US); Jan Zirnstein, Atlanta, GA (US); Andrew Harper, Atlanta, GA (US); Sabina Azizli, Fulshear, TX (US); Louis Lattanzio, Mount Prospect, IL (US)

(73) Assignee: Honeywell International Inc., Charlotte, NC (US)

(21) Appl. No.: 18/940,287

(22) Filed: Nov. 7, 2024

(51) Int. Cl. G05B 23/02

(52) U.S. Cl. CPC G05B 23/0286; G05B 23/024

(57) ABSTRACT

Embodiments of the present disclosure provide techniques for fault detection and mitigation. Plant data associated with one or more process assets of a process plant may be received. Fault data comprising at least one fault with at least one process asset may be generated based on the plant data and a set of conditions by applying the plant data to a fault monitoring machine learning model. Fault mitigating data for the at least one fault may be generated. The fault mitigating data may comprise one or more recommendations for minimizing potential impact of the at least one fault. Performance of one or more fault mitigation actions may be generated.

### TECHNICAL FIELD

The present disclosure relates, generally, to fault detection. Example embodiments provide systems, apparatuses, methods, and computer program products for intelligent fault detection and mitigation.

### BACKGROUND

In various contexts, processing plants include various assets, such as equipment, machines, and/or devices. Applicant has discovered problems with current implementations of fault detection in processing plant systems. Through applied effort, ingenuity, and innovation, Applicant has solved many of these identified problems by developing solutions embodied in the present disclosure, which are described in detail below.

### BRIEF SUMMARY

In accordance with one aspect of the present disclosure, a computer-implemented method for early anti-ice valve fault is provided. The computer-implemented method is executable using any of a myriad of computing device(s) and/or combinations of hardware, software, and/or firmware. In some example embodiments, an example computer-implemented method includes receiving, by one or more processors, plant data associated with one or more process assets of a process plant; generating, by the one or more processors, fault data comprising at least one fault with at least one process asset of the one or more process assets based on the plant data and a set of conditions by applying the plant data to a fault monitoring machine learning model configured to: (i) identify from the plant data, one or more process measurements for one or more process parameters, (ii) apply the one or more process measurements to the set of conditions, wherein the set of conditions comprise the one or more process parameters and one or more thresholds for the one or more process parameters, and (iii) generate the fault data indicative of the at least one fault in response to determining that the one or more process measurements satisfy the set of conditions; generating, by the one or more processors, fault mitigating data for the at least one fault, wherein the fault mitigating data comprises one or more recommendations for minimizing potential impact of the at least one fault; and initiating, by the one or more processors, performance of one or more fault mitigation actions.

In some embodiments, the one or more process measurements comprise sensor data from one or more sensors associated with the one or more process assets.

In some embodiments, the one or more process measurements comprise laboratory data from one or more measuring devices.

In some embodiments, the fault monitoring machine learning model is a first principles-based machine learning model.

In some embodiments, the fault monitoring machine learning model comprise one of a decision tree algorithm, random forest algorithm, XGBoost algorithm, or CatBoost algorithm.

In some embodiments, the example method further includes retrieving historical plant data from one or more databases; applying first principles to the historical plant data to generate training data, wherein the training data comprises a plurality of ground truth exception-based alerts; and training the fault monitoring machine learning model based on the training data and using a tree-based algorithm.

In some embodiments, the fault monitoring machine learning model defines a fault tree, and wherein the set of one or more conditions comprise a portion of the fault tree.

In some embodiments, initiating performance of one or more fault mitigation actions comprises transmitting instructions configured to cause modification of at least one process asset.

In some embodiments, initiating performance of one or more fault mitigation actions comprises providing the fault data for display on a user interface of a client computing entity.

In some embodiments, initiating performance of one or more fault mitigation actions comprises providing the fault mitigating data for display on a user interface of a client computing entity.

In accordance with another aspect of the present disclosure, an apparatus is provided. In some example embodiments, the apparatus comprises at least one processor and at least one memory storing instructions that, when executed by the at least one processor, cause the apparatus to receive plant data associated with one or more process assets of a process plant; generate fault data comprising at least one fault with at least one process asset of the one or more process assets based on the plant data and a set of conditions by applying the plant data to a fault monitoring machine learning model configured to: (i) identify from the plant data, one or more process measurements for one or more process parameters, (ii) apply the one or more process measurements to the set of conditions, wherein the set of conditions comprise the one or more process parameters and one or more thresholds for the one or more process parameters, and (iii) generate the fault data indicative of the at least one fault in response to determining that the one or more process measurements satisfy the set of conditions; generate fault mitigating data for the at least one fault, wherein the fault mitigating data comprises one or more recommendations for minimizing potential impact of the at least one fault; and initiate performance of one or more fault mitigation actions.

In some embodiments, the one or more process measurements comprise sensor data from one or more sensors associated with the one or more process assets.

In some embodiments, the one or more process measurements comprise laboratory data from one or more measuring devices.

In some embodiments, the fault monitoring machine learning model is a first principles-based machine learning model.

In some embodiments, the fault monitoring machine learning model comprise one of a decision tree algorithm, random forest algorithm, XGBoost algorithm, or CatBoost algorithm.

In some embodiments, the apparatus is further caused to retrieve historical plant data from one or more databases; apply first principles to the historical plant data to generate training data, wherein the training data comprises a plurality of ground truth exception-based alerts; and train the fault monitoring machine learning model based on the training data and using a tree-based algorithm.

In some embodiments, the fault monitoring machine learning model defines a fault tree, and wherein the set of one or more conditions comprise a portion of the fault tree.

In some embodiments, initiating performance of one or more fault mitigation actions comprises transmitting instructions configured to cause modification of at least one process asset.

In some embodiments, initiating performance of one or more fault mitigation actions comprises providing the fault data for display on a user interface of a client computing entity.

In accordance with another aspect of the present disclosure, a computer program product is provided. The computer program product in some embodiments includes at least one non-transitory computer-readable storage medium having computer coded instructions configured to, when executed by at least one processor receive plant data associated with one or more process assets of a process plant; generate fault data comprising at least one fault with at least one process asset of the one or more process assets based on the plant data and a set of conditions by applying the plant data to a fault monitoring machine learning model configured to: (i) identify from the plant data, one or more process measurements for one or more process parameters, (ii) apply the one or more process measurements to the set of conditions, wherein the set of conditions comprise the one or more process parameters and one or more thresholds for the one or more process parameters, and (iii) generate the fault data indicative of the at least one fault in response to determining that the one or more process measurements satisfy the set of conditions; generate fault mitigating data for the at least one fault, wherein the fault mitigating data comprises one or more recommendations for minimizing potential impact of the at least one fault; and initiate performance of one or more fault mitigation actions.

### BRIEF DESCRIPTION OF THE SEVERAL VIEWS OF THE DRAWINGS

Having thus described the embodiments of the disclosure in general terms, reference now will be made to the accompanying drawings, which are not necessarily drawn to scale, and wherein:

FIG. 1 illustrates a block diagram of an example system architecture in which embodiments of the present disclosure may operate.

FIG. 2 illustrates a block diagram of an example apparatus in accordance with at least one example embodiment of the present disclosure.

FIG. 3 illustrates a data flow diagram showing example data structures for fault detection and mitigation in accordance with at least one example embodiment of the present disclosure.

FIG. 4 illustrates flowchart including operations of an example process for fault detection and mitigation in accordance with at least one example embodiment of the present disclosure.

### DETAILED DESCRIPTION

Various embodiments of the present disclosure now will be described more fully hereinafter with reference to the accompanying drawings, in which some, but not all, embodiments of the present disclosure are shown. Indeed, the present disclosure may be embodied in many different forms and should not be construed as limited to the embodiments set forth herein, rather, these embodiments are provided so that this disclosure will satisfy applicable legal requirements.

The term “or” is used herein in both the alternative and conjunctive sense, unless otherwise indicated. The terms “illustrative” and “example” are used to be examples with no indication of quality level. Terms such as “computing,” “determining,” “generating,” and/or similar words are used herein interchangeably to refer to the creation, modification, or identification of data. Further, “based on,” “based at least in part on,” “based at least on,” “based upon,” and/or similar words are used herein interchangeably in an open-ended manner such that they do not indicate being based only on or based solely on the referenced element or elements unless so indicated. Like numbers refer to like elements throughout.

### Overview and Technical Improvements

Various embodiments of the present disclosure are generally directed to systems, apparatuses, methods, and computer program products for fault detection and mitigation in processing plant systems. Example embodiments disclosed herein address technical challenges associated with detecting faults with process assets and mitigating the impact of such faults.

A processing plant system associated with or otherwise embodying a processing plant generally include several process assets that be complex such that conventional systems fail to holistically analyze process assets, which can lead to poor performance of such conventional systems. In particular, conventional systems focus on individual process assets when monitoring for fault.

Example embodiments of the present disclosure solve the above challenges and other challenges associated with fault detection and mitigation. Example embodiments intelligently and holistically detect and mitigate faults associated with process assets by developing a specially configured fault monitoring machine learning model that integrates first principles knowledge with machine learning that provides for holistic and efficient analysis of process assets to detect faults and mitigate against such faults.

Example embodiments, represent first principles knowledge in the form of sensor data enrichment and exception-based alerts. Example embodiments collect process measurements from sensors associated with a process plant and/or laboratory data and enrich the process measurements using first principles. Example embodiments generate a fault tree defining one or more sets of conditions and train a machine learning model to learning events indicative of a fault based on first principles.

Example embodiments leverage machine learning techniques such as tree-based algorithms to train a fault monitoring machine learning model to learn, incorporating first principles knowledge into the tree-based algorithm to provide for automatic detection of alert events. In example embodiments, the fault monitoring machine learning model is configured to identify optimal solutions to minimize and/or avoid impact of process asset faults. Example embodiments, provide mitigation recommendations to resolve a fault or avoid potential adverse events. In this regard, example embodiments provide various technical advantages and improve various technical fields including fault detection and mitigation systems.

### Definitions

Many modifications and other embodiments of the disclosure set forth herein will come to mind to one skilled in the art to which this disclosure pertains having the benefit of the teachings presented in the foregoing description and the associated drawings. Therefore, it is to be understood that the embodiments are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in one embodiment,” “according to one embodiment,” “in some embodiments,” and the like generally mean that the particular feature, structure, or characteristic following the phrase may be included in at least one embodiment of the present disclosure, and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such a component or feature may be optionally included in some embodiments, or it may be excluded.

The terms “about,” “approximately,” or the like, when used with a number, may mean that specific number, or alternatively, a range in proximity to the specific number, as understood by persons of skill in the art field.

The term “plurality” refers to two or more items.

The term “set” refers to a collection of one or more items.

As used herein, the terms “data,” “content,” “digital content,” “information,” and similar terms may be used interchangeably to refer to data capable of being transmitted, received, and/or stored in accordance with embodiments of the present disclosure. Further, where a computing entity is described herein to receive data from another computing entity, it will be appreciated that the data may be received directly from another computing entity or may be received indirectly via one or more intermediary computing entities, such as, for example, one or more servers, relays, routers, network access points, base stations, hosts, and/or the like, sometimes referred to herein as a “network.” Similarly, where a computing entity is described herein to send data to another computing device, it will be appreciated that the data may be sent directly to another computing entity or may be sent indirectly via one or more intermediary computing devices, such as, for example, one or more servers, relays, routers, network access points, base stations, hosts, and/or the like.

The terms “machine learning module,” “machine learning model,” “ML module(s),” “ML model(s),” artificial intelligence,” or “AI” refer to a machine learning or deep learning task or mechanism. The term “machine learning” refers to a method used to devise complex models and algorithms that lend themselves to prediction. A machine learning model is a computer-implemented algorithm that may learn from data with or without relying on rules-based programming. These models enable reliable, repeatable decisions and results and uncovering of hidden insights through machine-based learning from historical relationships and trends in the data. In some embodiments, the machine learning model is a clustering model, a regression model, a neural network, a random forest, a decision tree model, a classification model, a large language model as defined above, or the like.

A machine learning model may be initially fit or trained on a training dataset (e.g., a set of examples used to fit the parameters of the model). The model may be trained on the training dataset using supervised or unsupervised learning. The model may be run with the training dataset and produce a result, which is then compared with a target, for each input vector in the training dataset. Based on the result of the comparison and the specific learning algorithm being used, the parameters of the model may be adjusted.

The machine learning models as described herein may make use of multiple ML engines (e.g., for analysis, transformation, and other needs). The system may train different artificial intelligence and/or machine learning (AI/ML) models for different needs and different ML-based engines. The system may generate new models (based on the gathered training data) and may evaluate their performance against the existing models. Training data may include any of the gathered information, as well as information on actions performed based on the various recommendations.

The AI/ML models may be any suitable model for the task or activity implemented by each ML-based engine. Machine learning models may be some form of neural network. The underlying AI/ML models may be learning models (supervised or unsupervised). As examples, such algorithms may be prediction (e.g., linear regression) algorithms, classification (e.g., decision trees) algorithms, time-series forecasting (e.g., regression-based) algorithms, association algorithms, clustering algorithms (e.g., K-means clustering, Gaussian mixture models, DBscan), or Bayesian methods (e.g., Naïve Bayes, Bayesian model averaging, Bayesian adaptive trials), image to image models (e.g., FCN, PSPNet, U-Net) sequence to sequence models (e.g., RNNs, LSTMs, BERT, Autoencoders) or Generative models (e.g., GANs).

The AI/ML models may implement statistical algorithms, such as dimensionality reduction, hypothesis testing, one-way analysis of variance (ANOVA) testing, principal component analysis, conjoint analysis, neural networks, support vector machines, decision trees (including random forest methods), ensemble methods, and other techniques. Other ML models may be generative models (such as Generative Adversarial Networks or auto-encoders, generative pre-trained transformer (GPT) model, or the like).

In various embodiments, the AI/ML models may undergo a training or learning phase before they are released into a production or runtime phase or may begin operation with models from existing systems or models. During a training or learning phase, the AI/ML models may be tuned to focus on specific variables, to reduce error margins, or to otherwise optimize their performance. The AI/ML models may initially receive input from a wide variety of data, such as the gathered data described herein. The ML models herein may undergo a second or multiple subsequent training phases for retraining the models.

### Example Systems and Apparatuses of the Disclosure

Embodiments of the present disclosure may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established, or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

A non-volatile computer-readable storage medium may include a floppy disk, flexible disk, hard disk, solid-state storage (SSS) (e.g., a solid-state drive (SSD), solid-state card (SSC), solid-state module (SSM)), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

A volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may also be implemented as methods, apparatus, systems, computing devices, computing entities, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that comprises a combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. Accordingly, the block diagrams and flowchart illustrations support various combinations of embodiments for performing the specified instructions, operations, or steps.

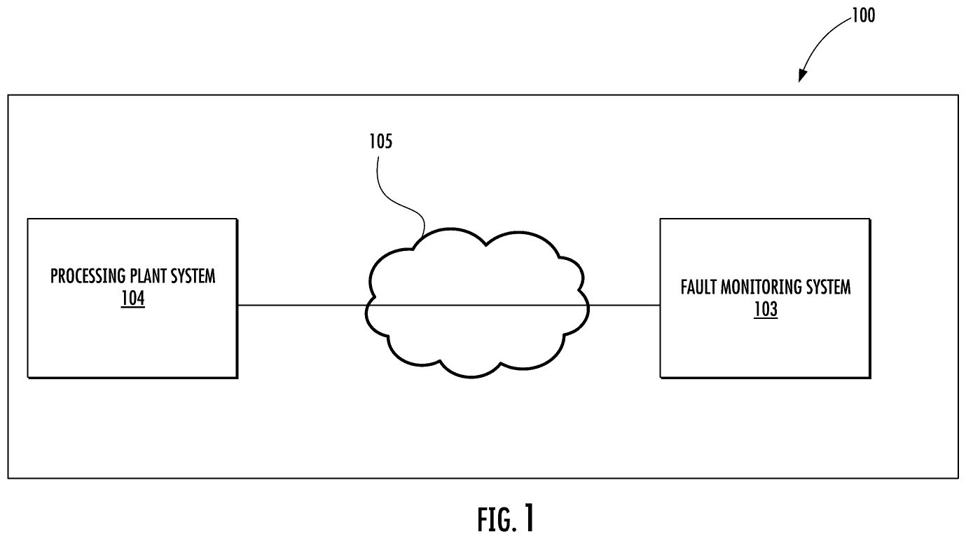

In this regard, FIG. 1 provides an example overview of a system architecture 100 in accordance with at least some example embodiments of the present disclosure. The depiction of the example architecture 100 is not intended to limit or otherwise confine the embodiments described and contemplated herein to any particular configuration of elements or systems, nor is it intended to exclude any alternative configurations or systems for the set of configurations and systems that can be used in connection with embodiments of the present disclosure. Rather, FIG. 1 and the architecture 100 disclosed therein is merely presented to provide an example basis and context for the facilitation of some of the features, aspects, and uses of the methods, apparatuses, computer readable media, and computer program products disclosed and contemplated herein. It will be understood that while many of the aspects and components presented in FIG. 1 are shown as discrete, separate elements, other configurations may be used in connection with the methods, apparatuses, computer readable media, and computer programs described herein, including configurations that combine, omit, separate, and/or add aspects and/or components. The example system architecture 100 may be used in a plurality of domains and not limited to any specific application as disclosed herewith. In particular, while some example embodiments are described herein with reference to processing plant domain, the example system architecture 100 may be used in a plurality of domains and limited to any specific application as disclosed herein. The plurality of domains may include healthcare, industrial, manufacturing, education, retail, to name a few.

As illustrated, the system architecture 100 includes a processing plant system 104 in communication with a fault monitoring system 103. In some embodiments, the processing plant system 104 communicates with the fault monitoring system 103 over one or more communications network(s), for example a communications network 105.

It should be appreciated that the communications network 105 in some embodiments is embodied in any of a myriad of network configurations. In some embodiments, the communications network 105 embodies a public network (e.g., the Internet). In some embodiments, the communications network 105 embodies a private network (e.g., an internal localized, or closed-off network between particular devices). In some other embodiments, the communications network 105 embodies a hybrid network (e.g., a network enabling internal communications between particular connected devices and external communications with other devices). The communications network 105 in some embodiments includes one or more base station(s), relay(s), router(s), switch(es), cell tower(s), communications cable(s) and/or associated routing station(s), and/or the like. In some embodiments, the communications network 105 includes one or more user-controlled computing device(s) (e.g., a user owned router and/or modem) and/or one or more external utility devices (e.g., Internet service provider communication tower(s) and/or other device(s)).

Each of the components of the system architecture 100 may be communicatively coupled to transmit data to and/or receive data from one another over the same or different wireless and/or wired networks embodying the communications network 105. Such configuration(s) include, without limitation, a wired or wireless Personal Area Network (PAN), Local Area Network (LAN), Metropolitan Area Network (MAN), Wide Area Network (WAN), and/or the like. Additionally, while FIG. 1 illustrate certain system entities as separate, standalone entities communicating over the communications network 105, the various embodiments are not limited to this architecture. In other embodiments, one or more computing entities share one or more components, hardware, and/or the like, or otherwise are embodied by a single computing device such that connection(s) between the computing entities are over the communications network 105 are altered and/or rendered unnecessary. For example, in some embodiments, the processing plant system 104 includes some or all of the fault monitoring system 103, such that an external communications network 105 is not required.

In some embodiments, the processing plant system 104 and the fault monitoring system 103 are embodied in an on-premises system within or associated with a processing plant. In some such embodiments, the processing plant system 104 and the fault monitoring system 103 may be communicatively coupled via at least one wired connection. Alternatively or additionally, in some embodiments, the processing plant system 104 embodies or includes the fault monitoring system 103, for example as a software component of a single enterprise terminal.

In some embodiments, the processing plant system 104 is associated with or otherwise embodies a processing plant configured for producing one or more products. Non-limiting examples of such processing plant include a chemical plant, petrochemical plant, refinery plant, and/or the like. In some embodiments, the processing plant system 104 includes any number of computing device(s), system(s), physical component(s), and/or the like that facilitates producing of any number of products, for example utilizing particular configurations that cause processing of particular inputs available within the processing plant system 104. Such computing device(s), system(s), physical component(s) may represent process asset(s) associated with the processing plant system 104.

A chemical plant, petrochemical, and/or refinery plant, for example, may include one or more physical components (e.g., pieces of equipment, machines, or the like) that process one or more input chemicals to create one or more products. By way of non-limiting example, certain refinery plants may comprise physical component(s) embodying blender(s), product repository(s), and/or other component(s) that perform particular process(es) to alter properties of inputs to the component, crude flow unit(s), piping between such physical component(s), valve(s) controlling flow between the physical component(s), and/or the like. By way of another non-limiting example, certain chemical plants may include a dehydrogenation system comprising a plurality of reactors and heaters. The reactors and heaters may be arranged such that the heaters are positioned upstream from each reactor and hydrocarbon feed stream is heated by each of the heaters and undergoes reactions in the reactors.

In some embodiments, the processing plant system 104 includes one or more physical component(s), connection(s) between physical component(s), and/or computing system(s) that control operation of each physical component therein or a portion of the physical components therein. Alternatively or additionally, in some embodiments the processing plant system 104 includes one or more computing system(s) that are specially configured to operate the physical component(s) in a manner that produces one or more particular product(s) simultaneously.

In some embodiments, processing plant system 104 includes one or more computing device(s) and/or system(s) embodied in hardware, software, firmware, and/or a combination thereof, that configure and/or otherwise control operation of one or more physical component(s) in the processing plant. For example, in some embodiments, such computing device(s) and/or system(s) include one or more programmable logic controller(s), MPC(s), application server(s), centralized control system(s), and/or the like, that control(s) configuration and/or operation of at least one physical component. It will be appreciated that different processing plant system(s) may include different physical component(s), computing system(s), and/or the like. For example, different refinery plants may include different components, different number of components, different types of components, and/or the like, that cause the processing plant system to operate differently from other refinery plants.

In some embodiments, the processing plant system 104 includes one or more sensors and/or other devices configured sensing, measuring, and/or collecting process measurements (e.g., process data) for one or more process parameter to, for example, monitor conditions in, around, and on process assets (e.g., process equipment such as boilers, reactors, and/or the like). Such sensors may include, but are not limited to temperature sensors, level sensors, gas chromatographs, pressure sensors, vibration sensors, moisture sensors, ultrasonic sensors, thermal cameras, disc sensors, weight sensors, capacitance sensors, differential pressure sensors, and/or the like. Example conditions that may be monitored in a processing plant includes, but not limited to, temperature (e.g., inlet temperature, reactor temperature, environment temperature, and/or the like), pressure, flow rate, composition, molecular weight, PH, specific weight, feed consumption, production rate, and/or the like. In some embodiments, the sensor(s) may be configured to sense, measure, and/or collect process measurements periodically (e.g., every 20 minutes, hourly, daily, a combination thereof, and/or the like). Additionally, in some embodiments, the processing plant system 104 may include one or more measuring devices for measuring and/or collecting process laboratory measurements. Non-limiting examples of such measuring devices include gas chromatographs, liquid chromatographs, and/or the like. In some embodiments a sensor may include transmitter and/or deviation alarm such that the sensor may be programmed to set off an alarm (e.g., visual alarm, audible alarm, and/or the like)

In some embodiments, the fault monitoring system 103 may be one or more computing devices, such as one or more servers (e.g., cloud computing system) configured to perform various functionalities associated with fault monitoring, including fault detection and mitigation. Although, the fault monitoring system 103 is depicted as a single element in FIG. 1, the fault monitoring system 103 may be a distributed network of computing devices located in a plurality of different locations. For example, the fault monitoring system 103 may operate on a plurality of different servers distributed across various geographic areas. The fault monitoring system 103 may comprise instructions executed by one or more processors.

In some embodiments, the fault monitoring system 103 is configured via hardware, software, firmware, and/or a combination thereof to receive plant data from the plant system 104 and generate fault data comprising one or more predicted faults with one or more process assets. The plant data may comprise process measurements from one or more sensors associated with the processing plant system 104 as described above, process laboratory measurements from laboratory testing as described above, and/or other data. In this regard, in some embodiments, the fault monitoring system 103 is configured via hardware, software, firmware, and/or a combination thereof to detect and/or predict fault(s) associated with process assets based on the plant data associated with one or more process assets.

In some embodiments, the fault monitoring system 103 is configured via hardware, software, firmware, and/or a combination thereof to process and/or analyze the received plant data such as performing fault detection operations to generate fault data, as described above. Additionally, in some embodiments, the fault monitoring system 103 is configured via hardware, software, firmware, and/or a combination thereof to perform fault mitigating analysis and generate fault mitigating data for the fault data generated such that the impact of the detected and/or predicted fault is minimized. In some embodiments, the fault mitigating data comprises one or more recommended solutions for resolving a detected fault and/or one or more solutions for preventing a predicted fault from occurring. In this regard, the fault monitoring system 103 may be configured to determine corrective actions for one or more detected faults with a process asset.

In some embodiments the fault monitoring system 103, using or more techniques, may be configured to determine if plant data (or portion thereof) satisfies a set of conditions defined by a first principles-based fault monitoring machine learning model. Such set of conditions may comprise one or more process parameters and/or process parameters along with corresponding threshold data (e.g., threshold values, threshold ranges, and/or the like). For example, in some embodiments, plant data (or portion thereof) is compared to threshold data for the one or more process parameters to determine if a process asset is associated with an abnormal condition.

In some embodiments, the fault monitoring system 103 is configured via hardware, software, firmware, and/or a combination thereof to apply plant data received from a processing plant system 104 to a fault monitoring machine learning model (e.g., first principles-based fault monitoring machine learning model) configured, trained, and/or the like to support, facilitate, and/or perform one or more functionalities associated with the fault monitoring system 103, such as fault detection and/or fault mitigation. For example, in some embodiments, the fault monitoring system 103 is configured via hardware, software, firmware, and/or a combination thereof to execute a fault monitoring machine learning model in response to receiving plant data.

In some embodiments, the fault monitoring system 103 is configured via hardware, software, firmware, and/or a combination thereof to perform one or more preprocessing operations on the plant data before applying the plant data to the fault monitoring machine learning model. In some embodiments, such preprocessing operation may comprise extracting relevant portion of the received plant data and providing the extracted portion as input to the fault monitoring machine learning model.

In this regard, in some embodiments, the fault monitoring system 103 may be configured to generate fault data comprising at least one fault with at least one process asset based on plant data and a set of conditions by applying the plant data to a fault monitoring machine learning model configured to: (i) identify from the plant data, one or more process measurements for one or more process parameters, (ii) apply the one or more process measurements to the set of conditions, wherein the set of conditions comprise the one or more process parameters and one or more thresholds for the one or more process parameters, and (iii) generate the fault data indicative of the at least one fault in response to determining that the one or more process measurements satisfy the set of conditions. The fault monitoring system 103 may be configured to generate fault mitigating data for the at least one fault, wherein the fault mitigating data comprises one or more recommendations for minimizing potential impact of the at least one fault.

In some embodiments, the fault monitoring system 103 is configured to develop, train or otherwise generate the fault monitoring machine learning model using historical plant data and first principles knowledge such that the fault monitoring machine learning model comprises a fault tree that reflects first principles knowledge or otherwise first principles model. The fault tree may comprise one or more set of conditions (as described above). In some examples the machine learning model comprises a decision tree algorithm, random forest algorithm, extreme gradient boosting (XGBoost) algorithm, CatBoost algorithm, or other tree-based algorithm to facilitate generation and application of a fault tree and, thus the fault monitoring machine learning model.

In some embodiments, the fault monitoring system 103 is configured to train the fault monitoring machine learning model to determine optimal solution(s) to resolve detected fault(s) and/or optimal solution(s) to mitigate and/or avoid the impact of a detected or predicted fault with a process asset, such as impact to the process asset itself (e.g., process asset life), impact to other process assets, production, and/or the like. For example, the fault tree defined by the fault monitoring machine learning model may comprise a logical combination of a set of conditions associated with each of a plurality of process assets such that holistic fault detection and fault mitigation may be performed. In this regard, the fault monitoring system 103 may be configured to drill down or otherwise traverse a fault tree associated with a plurality of process assets to detect and predict faults with any of the plurality of process assets and the root cause, which may originate from other process assets linked or otherwise associated with the process asset identified as being associated with a fault.

In some embodiments, the fault monitoring system 103 is configured via hardware, software, firmware, and/or a combination thereof to initiate performance of one or more fault mitigation action(s). In some embodiments, the performance of the fault mitigation action(s) comprises generate an alert and/or notification and causing the alert and/or notification to be rendered on a display on a client computing device (e.g., via a user interface). The fault monitoring machine learning model may define such alerts (e.g., exception-based alerts). For example, a set of conditions may be associated with an alert, such that when the plant data satisfies the set of conditions, the fault monitoring system 103 may be configured to cause generation and transmission of the corresponding alert.

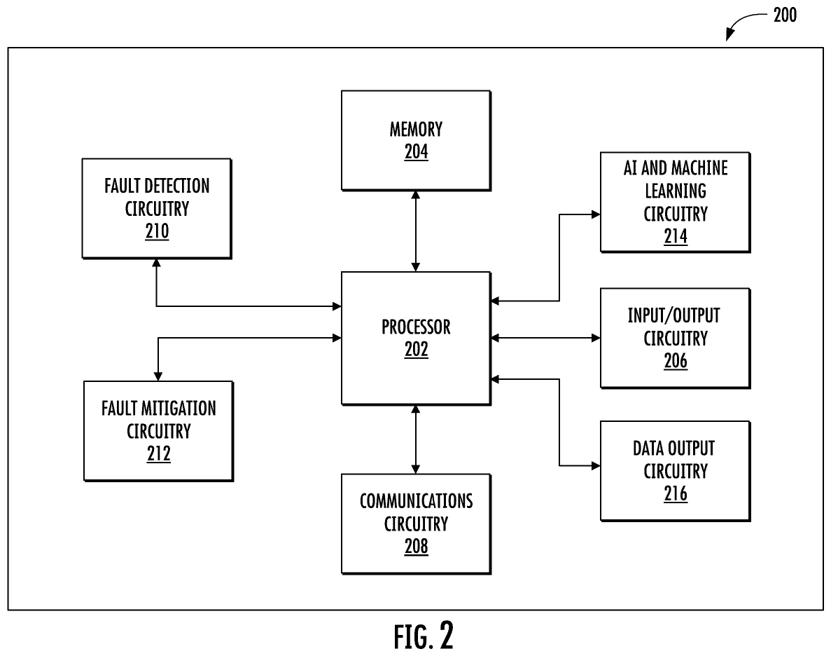

FIG. 2 illustrates a block diagram of an example apparatus that may be specially configured in accordance with at least one example embodiment of the present disclosure. Specifically, FIG. 2 depicts an example fault monitoring apparatus 200 (“apparatus 200”) specially configured in accordance with at least some example embodiments of the present disclosure. In some embodiments, the fault monitoring system 103 and/or a portion thereof is embodied by one or more system(s), such as the apparatus 200 as depicted and described in FIG. 2. The apparatus 200 includes processor 202, memory 204, input/output circuitry 206, communications circuitry 208, fault detection circuitry 210, fault mitigation circuitry 212, AI and machine learning circuitry 214, and/or data output circuitry 216. In some embodiments, the apparatus 200 is configured, using one or more of the sets of circuitry embodied by processor 202, memory 204, input/output circuitry 206, communications circuitry 208, fault detection circuitry 210, fault mitigation circuitry 212, AI and machine learning circuitry 214, and/or data output circuitry 216 to execute and perform the operations described herein.

In general, the terms computing entity (or “entity” in reference other than to a user), device, system, and/or similar words used herein interchangeably may refer to, for example, one or more computers, computing entities, desktop computers, mobile phones, tablets, phablets, notebooks, laptops, distributed systems, items/devices, terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably. In this regard, the apparatus 200 embodies a particular, specially configured computing entity transformed to enable the specific operations described herein and provide the specific advantages associated therewith, as described herein.

Although components are described with respect to functional limitations, it should be understood that the particular implementations necessarily include the use of particular computing hardware. It should also be understood that in some embodiments certain of the components described herein include similar or common hardware. For example, in some embodiments two sets of circuitry both leverage use of the same processor(s), network interface(s), storage medium(s), and/or the like, to perform their associated functions, such that duplicate hardware is not required for each set of circuitry. The use of the term “circuitry” as used herein with respect to components of the apparatuses described herein should therefore be understood to include particular hardware configured to perform the functions associated with the particular circuitry as described herein.

Particularly, the term “circuitry” should be understood broadly to include hardware and, in some embodiments, software for configuring the hardware. For example, in some embodiments, “circuitry” includes processing circuitry, storage media, network interfaces, input/output devices, and/or the like. Alternatively or additionally, in some embodiments, other elements of the apparatus 200 provide or supplement the functionality of another particular set of circuitry. For example, the processor 202 in some embodiments provides processing functionality to any of the sets of circuitry, the memory 204 provides storage functionality to any of the sets of circuitry, the communications circuitry 208 provides network interface functionality to any of the sets of circuitry, and/or the like.

In some embodiments, the processor 202 (and/or co-processor or any other processing circuitry assisting or otherwise associated with the processor) is/are in communication with the memory 204 via a bus for passing information among components of the apparatus 200. In some embodiments, for example, the memory 204 is non-transitory and may include, for example, one or more volatile and/or non-volatile memories. In other words, for example, the memory 204 in some embodiments includes or embodies an electronic storage device (e.g., a computer readable storage medium). In some embodiments, the memory 204 is configured to store information, data, content, applications, instructions, or the like, for enabling the apparatus 200 to carry out various functions in accordance with example embodiments of the present disclosure.

The processor 202 may be embodied in a number of different ways. For example, in some example embodiments, the processor 202 includes one or more processing devices configured to perform independently. Additionally or alternatively, in some embodiments, the processor 202 includes one or more processor(s) configured in tandem via a bus to enable independent execution of instructions, pipelining, and/or multithreading. The use of the terms “processor” and “processing circuitry” should be understood to include a single core processor, a multi-core processor, multiple processors internal to the apparatus 200, and/or one or more remote or “cloud” processor(s) external to the apparatus 200.

In an example embodiment, the processor 202 is configured to execute instructions stored in the memory 204 or otherwise accessible to the processor. Alternatively or additionally, the processor 202 in some embodiments is configured to execute hard-coded functionality. As such, whether configured by hardware or software methods, or by a combination thereof, the processor 202 represents an entity (e.g., physically embodied in circuitry) capable of performing operations according to an embodiment of the present disclosure while configured accordingly. Alternatively or additionally, as another example in some example embodiments, when the processor 202 is embodied as an executor of software instructions, the instructions specifically configure the processor 202 to perform the algorithms embodied in the specific operations described herein when such instructions are executed. As one particular example embodiment, the processor 202 is configured to perform various operations associated with performing improved asset monitoring associated with a processing plant system.

In some embodiments, the apparatus 200 includes input/output circuitry 206 that provides output to the user and, in some embodiments, to receive an indication of a user input. In some embodiments, the input/output circuitry 206 is in communication with the processor 202 to provide such functionality. The input/output circuitry 206 may comprise one or more user interface(s) and in some embodiments includes a display that comprises the interface(s) rendered as a web user interface, an application user interface, a user device, a backend system, or the like. In some embodiments, the input/output circuitry 206 also includes a keyboard, a mouse, a joystick, a touch screen, touch areas, soft keys a microphone, a speaker, or other input/output mechanisms. The processor 202 and/or input/output circuitry 206 comprising the processor may be configured to control one or more functions of one or more user interface elements through computer program instructions (e.g., software and/or firmware) stored on a memory accessible to the processor (e.g., memory 204, and/or the like). In some embodiments, the input/output circuitry 206 includes or utilizes a user-facing application to provide input/output functionality to a client device and/or other display associated with a user.

In some embodiments, the apparatus 200 includes communications circuitry 208. The communications circuitry 208 includes any means such as a device or circuitry embodied in either hardware or a combination of hardware and software that is configured to receive and/or transmit data from/to a network and/or any other device, circuitry, or module in communication with the apparatus 200. In this regard, in some embodiments the communications circuitry 208 includes, for example, a network interface for enabling communications with a wired or wireless communications network. Additionally or alternatively in some embodiments, the communications circuitry 208 includes one or more network interface card(s), antenna(s), bus(es), switch(es), router(s), modem(s), and supporting hardware, firmware, and/or software, or any other device suitable for enabling communications via one or more communications network(s). Additionally or alternatively, the communications circuitry 208 includes circuitry for interacting with the antenna(s) and/or other hardware or software to cause transmission of signals via the antenna(s) or to handle receipt of signals received via the antenna(s). In some embodiments, the communications circuitry 208 enables transmission to and/or receipt of data from user device, one or more asset(s) or accompanying sensor(s), and/or other external computing device in communication with the apparatus 200.

In some embodiments, the apparatus 200 includes fault detection circuitry 210. The fault detection circuitry 210 includes hardware, software, firmware, and/or a combination thereof, that supports process fault detection as described herein. For example, in some embodiments, the fault detection circuitry 210 includes hardware, software, firmware, and/or a combination thereof, configured to, with the processing circuitry 202, input/output circuitry 206 and/or communications circuitry 208, perform one or more functions associated with fault detection. In some embodiments, the fault detection circuitry 210 includes a separate processor, specially configured field programmable gate array (FPGA), or a specially programmed application specific integrated circuit (ASIC).

In some embodiments, the apparatus 200 includes fault mitigation circuitry 212. The fault mitigation circuitry 212 includes hardware, software, firmware, and/or a combination thereof, that supports process fault mitigation as described herein. For example, in some embodiments, the fault mitigation circuitry 212 includes hardware, software, firmware, and/or a combination thereof, configured to, with the processing circuitry 202, input/output circuitry 206 and/or communications circuitry 208, perform one or more functions associated with fault mitigation. In some embodiments, the fault mitigation circuitry 212 includes a separate processor, specially configured field programmable gate array (FPGA), or a specially programmed application specific integrated circuit (ASIC).

In some embodiments, the apparatus 200 includes AI and machine learning circuitry 214 In some embodiments, the AI and machine learning circuitry 214 may include hardware, software, firmware, and/or a combination thereof designed and/or configured to request, receive, process, generate, and transmit data, data structures, control signals, and electronic information for training and executing a trained AI and/or machine learning model (AI/ML model) configured to facilitate the operations and/or functionalities described herein. For example, in some embodiments the AI and machine learning circuitry 214 includes hardware, software, firmware, and/or a combination thereof, that identifies training data and/or utilizes such training data for training a particular machine learning model, AI, and/or other model to generate particular output data based at least in part on learnings from the training data. Additionally or alternatively, in some embodiments, the AI and machine learning circuitry 214 includes hardware, software, firmware, and/or a combination thereof, that embodies or retrieves a trained machine learning model, AI and/or other specially configured model utilized to process inputted data. Additionally or alternatively, in some embodiments, the AI and machine learning circuitry 214 includes hardware, software, firmware, and/or a combination thereof that processes received data utilizing one or more algorithm(s), function(s), subroutine(s), and/or the like, in one or more preprocessing and/or subsequent operations that need not utilize a machine learning or AI model.

In some embodiments, the apparatus 200 may include a data output circuitry 216. In some embodiments, the data output circuitry 216 may include hardware, software, firmware, and/or a combination thereof, that configures and/or generates an output based at least in part on data processed by the apparatus 200. In some embodiments, the data output circuitry 216 includes hardware, software, firmware, and/or a combination thereof, that generates a particular report based at least in part on output of an optimization and/or validation operation according to one or more techniques of the present disclosure, for example where the report is generated based at least in part on a particular reporting protocol. Additionally or alternatively, in some embodiments, the data output circuitry 216 includes hardware, software, firmware, and/or a combination thereof, that configures a particular output data object, output data file, and/or user interface for storing, transmitting, and/or displaying. For example, in some embodiments, the data output circuitry 216 generates and/or specially configures a particular data output for transmission to another system sub-system for further processing. Additionally or alternatively, in some embodiments, the data output circuitry includes hardware, software, firmware, and/or a combination thereof, that causes rendering of a specially configured user interface based at least in part on data received by and/or processing by the apparatus 200.

Alternatively or additionally or in some embodiments, one or more of the sets of circuitries embodying processor 202, memory 204, input/output circuitry 206, communications circuitry 208, fault detection circuitry 210, fault mitigation circuitry 212, AI and Machine learning circuitry 214, and/or data output circuitry 216 perform some or all of the functionality described as associated with another component. For example, in some embodiments, two or more of the sets of circuitry embodied by processor 202, memory 204, input/output circuitry 206, communications circuitry 208, fault detection circuitry 210, fault mitigation circuitry 212, AI and Machine learning circuitry 214, and/or data output circuitry 216, are combined into a single module embodied in hardware, software, firmware, and/or a combination thereof. Similarly, in some embodiments, one or more of the sets of circuitry, for example fault detection circuitry 210, is/are combined with the processor 202, such that the processor 202 performs one or more of the operations described above with respect to each of these sets of circuitry embodied by the fault detection circuitry 210.

### Example System Operations

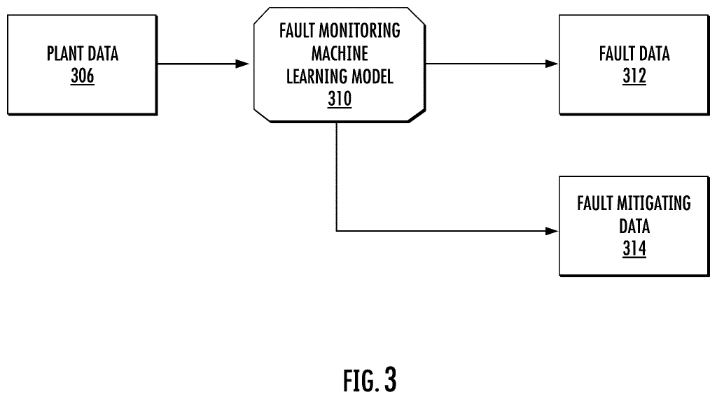

FIG. 3 is a data flow diagram showing example data structures for fault detection and mitigation in accordance with at least one example embodiment of the present disclosure.

In some embodiments, the fault monitoring system 103 is configured to receive plant data 306 associated with one or more process assets. In some embodiments, a process asset is any devices, equipment, machines, and/or other physical components within or associated with a processing plant and that facilitates producing of any number of products, for example utilizing particular configurations that cause processing of particular inputs available within the processing plant. A process asset, for example, may represent a process asset (e.g., one or more equipment) of a plurality of process assets in a processing plant. Non-limiting examples of process assets include compressors, blenders, boilers, reactors, heaters, and/or the like. As described, a processing plant system 104 may be associated with the processing plant and/or embody the processing plant. Non-limiting examples of a process plant include a chemical plant, a refinery plant, and/or the like.

In some embodiments, the fault monitoring system 103 receives the plant data 306 from the processing plant system 104 (e.g., associated with the processing plant and/or embodying the processing plant whose plant data is being received). In some embodiments, the plant data 306 comprises measurements (e.g., process measurement collected via one or more sensors and/or process laboratory measurement collected via one or more measuring devices) that represent values, ranges, scores, and/or the like for one or more process parameters and/or process parameters with respect to process assets associated with a processing plant.

In some embodiments, the process measurements (e.g., sensor data) from one or more sensors may comprise signals that describe changes with respect to one or more process parameters over a period of time. Example of such process parameters that may be associated with process assets include, but not limited to, composition, feed rate, temperature, pressure, performance metrics, environmental condition (e.g., key performance indicator (KPI)) and/or other process parameters that may impact the performance of a process and/or may be leveraged to monitor the performance and/or condition of a process and/or associated process assets. Non-limiting examples of sensors include temperature sensors, level sensors, online analyzers such as gas chromatographs, moisture sensors, ultrasonic sensors, thermal cameras, pressure sensors, position sensors, flow sensors, vibration sensors, weight sensors, capacitance sensors, differential pressure sensors, and/or the like.

In some embodiments, the plant data 306 may be received by the fault monitoring system 103 as a stream of data. For example, in some embodiments, the plant data 306 may comprise telemetry data. In some embodiments, the one or more items of data and/or signal may be received in real-time and/or near real-time from the processing plant system 104.

In some embodiments, the plant data 306 includes process measurement (e.g., as described above) that describe changes over a time period for one or more process parameters associated with the one or more process assets. For example, the sensor data (e.g., raw data and/or signal) from the one or more sensors may describe and/or reflect changes over a time period for one or more process parameters associated with the process asset(s). In the context of a chemical process, for example, sensor data from one or more sensors may describe changes over a time period for chemical processing, such as feed rates, changes in ion levels, and configuration modes. For example one or more sensors may be configured to measure composition data such as percentage of chloride in a solution. As another example, one or more sensors may be configured to measure feed rate, and so on.

In some embodiments, the fault monitoring system 103 is configured to generate fault data 312 based on the plant data 306. The fault data 312 may comprise one or more predicted faults indicative of one or more abnormal conditions with a process asset(s). In some embodiments, the fault monitoring system 103 is configured to generate the fault data 312 by applying the plant data 306 to a fault monitoring machine learning model 310 that is configured, trained, and/or the like to identify abnormal conditions associated with a process asset(s).

In some embodiments, the fault monitoring system 103 is configured to generate fault mitigating data 314. For example, in some embodiments, the fault monitoring machine learning model 310 is configured to determine potential impact of predicted fault(s). For example, the fault monitoring machine learning model 310 may be configured to determine potential effect and/or consequences of a predicted fault(s) with a process asset(s). In some embodiments, the fault monitoring machine learning model 310 is configured, trained, and/or the like to determine solution(s) to mitigate such potential impact of predicted fault(s) and/or solution(s) to resolve the predicted fault(s).

In some embodiments, the fault monitoring machine learning model 310 is a data entity that describes parameters, hyper-parameters, and/or defined operations of a rules-based algorithm, machine learning model (e.g., model including at least one or more rule-based layers, one or more layers that depend on trained parameters, coefficients, and/or the like), and/or artificial intelligence model, and/or the like. The fault monitoring machine learning model 310 may include any type of model configured, trained, and/or the like to perform predictive analysis task on plant data, such as plant data, to detect fault(s) associated with process assets. In this regard, the fault monitoring machine learning model 310 may be configured to utilize one or more of any types of machine learning, rules-based, and/or artificial intelligence techniques including one or more of supervised learning (e.g., using user feedback), unsupervised learning, semi-supervised learning, reinforcement learning, computer vision techniques, sequence modeling techniques, language processing techniques, neural network techniques, and/or generative artificial intelligence techniques.

In some embodiments, the fault monitoring machine learning model 310 defines a fault tree generated based at least in part using first principles model. In this regard, in some embodiments, the fault monitoring machine learning model 310 is a first principles-based fault monitoring machine learning model 310 (FP-based fault monitoring machine learning model) comprising one or more tree-based algorithms that incorporate first principles knowledge. In particular, the fault monitoring machine learning model 310 may comprise a first principles model and machine learning model integrated together such that the fault monitoring machine learning model 310 may learn, based on the first principles model, events that indicate an abnormal condition.

As further discussed below, the fault monitoring machine learning model 310 may be trained using historical plant data and first principles knowledge. Non-limiting of such tree-based algorithms include decision tree algorithm(s), random forest algorithm(s), XGBoost algorithm(s), CatBoost algorithm(s) and/or the like. The first principles model may be incorporated into the one or more tree-based algorithms in the form of sensor data enrichment and exception-based alerts (EBAs), as discussed further below.

In some embodiments, the fault tree defined by the fault monitoring machine learning model 310 comprise one or more sets of conditions that if satisfied indicates an abnormal condition. For example, a set of conditions may comprise one or more process parameters and corresponding threshold(s). The fault monitoring machine learning model 310 may be configured to predict the presence of an abnormal condition in response to determining that the relevant portion of the plant data satisfies the one or more process parameters.

In some embodiments, the one or more sets of conditions may comprise at least one set of conditions for each of the one or more process assets. In particular, in some embodiments, the fault tree comprises a plurality of sets of conditions representing a logical combination of the set(s) of conditions for each of a plurality of process assets.

The fault monitoring machine learning model 310 may be configured to perform nodal analysis and/or traverse the fault tree defined to identify contributing factors for an abnormal condition. For example, the fault tree may at least in part function as a fault propagation tree and/or root cause identification tree. The fault monitoring machine learning model 310 may be configured to drill down from a high level condition to a low level condition to learn and/or identify contribution factors to an abnormal condition at a granular level.

In some embodiments, a set of conditions may be associated with an alert (e.g., exception based alert). The fault monitoring system 103 may be configured, using the fault monitoring machine learning model 310, to cause an alert to be transmitted in response to determining that the set of condition associated with the alert is satisfied by the plant data (e.g., relevant portion thereof). In particular, in various embodiments, the fault monitoring system 103 may be configured to, using the fault monitoring machine learning model generate and provide an exception-based alert to one or more client computing devices in response to a corresponding set of conditions being satisfied by the plant data 306. As described above, a set of conditions or group of sets of conditions may be indicative of deviation from a normal mode of operation of one or more process assets.

As described above, the fault monitoring machine learning model may be trained based on historical plant data and first principles model. In some embodiments, the fault monitoring system 103 is configured to generate the fault monitoring machine learning model 310 (e.g., FP-based fault monitoring machine learning model 310). In some embodiments, generating the fault monitoring machine learning model 310 comprises developing and training the fault monitoring machine learning model 310 using historical plant data (e.g., past process data, past environmental condition data, and/or the other plant data) and first principles model.

In some embodiments, the fault monitoring system 103 leverages first principles to generate training data. In some embodiments, the fault monitoring system 103 is configured to apply first principles (e.g., first principles knowledge or data/information derived based on first principles knowledge) to the historical plant data to generate training data comprising a plurality of ground truth exception-based alerts. In some embodiments, the fault monitoring system 103 is configured to train the train the fault monitoring machine learning model based on the training data and using a tree-based algorithm. In some embodiments, a ground truth exception-based alert is an alert (e.g., past alert) that servers as training label in training data used to train a machine learning model, such as a fault monitoring machine learning model. For example, a ground-truth exception-based alert may comprise information (e.g., alert data) that is known to be true and/or obtained via direct observation or the like.

In some embodiments, the fault monitoring system 103 is configured to identify, receive, retrieve, aggregate, or otherwise obtain historical plant data comprising historical measurement data (e.g., sensor data). In some embodiments, the fault monitoring system 103 may be configured to retrieve the historical plant data from one or more databases storing such historical plant data. For example, the fault monitoring system 103 may be configured to previously receive the historical plant data from the processing plant system 104 and store the previously received historical plant data in one or more databases. Alternatively or additionally, in some embodiments, the fault monitoring system 103 may be configured to receive the historical plant data from the processing plant system 104 during the model development phase.

In some embodiments, the fault monitoring system 103 is configured to apply first principles (e.g., first principles knowledge or data/information derived based on first principles knowledge) to the historical plant data to generate training data comprising a plurality of ground truth exception-based alerts. In some embodiments, the fault monitoring system 103 is configured to train the fault monitoring machine learning model based on the training data and using a tree-based algorithm.

In some embodiments, the fault monitoring system 103 is configured to apply first principles model to the historical plant data to incorporate first principles such that that the historical plant data is enriched. The first principles model, for example, may represent first principles knowledge. In some embodiments, such first principles knowledge may originate from one or more sources. Non-limiting example of such one or more sources include domain knowledge experts. The historical plant data may comprise raw sensor signals and/or laboratory data. In some embodiments, applying first principles model to the historical plant data comprises generating one or more sets of conditions (as described above) based on first principles knowledge. As described above, each set of conditions may represent a fault logic of a larger fault tree indicative. In some embodiments, for each sensor signal (e.g., that describes changes in an operational parameter such as feed rate, ion level, and/or the like over a time period), a set of conditions is generated based on first principles knowledge. In some embodiments, a Boolean signal (e.g., Boolean signal of capsules) representing events indicative of an abnormal condition is generated based on the set of conditions. In the context of a chemical process, for example, a Boolean signal representing chemical events indicative of a fault (e.g., abnormal condition) with one or more process assets and/or processes is generated based on the set of conditions. A Boolean signal, for example may comprise a collection of data samples (e.g., data point/data value for a particular parameter at a particular timestamp) over a given time period. For example, a Boolean signal may be reflective of a timeseries data. In some embodiments, a Boolean signal of capsules refers to one or more capsules associated with one or more Boolean signals. In some embodiments, a capsule refers to a data structure that includes information about or related to one or more Boolean signals. For example, a capsule may be a bounded data structure (e.g., having a start time and end time) and may include one or more Boolean signals within a time period defined by the capsule. In some examples, a condition of the set of conditions in a fault logic comprises a collection of capsules. For example, a fault logic may include one or more conditions, where each condition comprises a collection of capsules.

In some embodiments, the fault monitoring system 103 is configured to combine the set of conditions generated for each of a plurality of signals to generate a second set of capsules indicating when the sets of conditions are simultaneously true. In some embodiments, the fault monitoring system 103 is trained to generate an alert indicating an abnormal condition when such even occurs (e.g., the set of conditions are satisfied).

By way of example, if based on first principles, it is known that chloride levels above 75% are indicative of an abnormal condition, a signal measuring the percentage of chloride in a solution combined with a condition >75% may generate a series of capsules that represent when the chloride level percentage exceeds 75%.

### Example Processes of the Disclosure

Having described example systems and apparatuses, data visualizations, and user interfaces in accordance with the disclosure, example processes of the disclosure will now be discussed. It will be appreciated that each of the flowcharts depicts an example computer-implemented process that is performable by one or more of the apparatuses, systems, devices, and/or computer program products described herein, for example utilizing one or more of the specially configured components thereof.

Although the example processes depicts a particular sequence of operations, the sequence may be altered without departing from the scope of the present disclosure. For example, some of the operations depicted may be performed in parallel or in a different sequence that does not materially affect the function of the processes.

The blocks indicate operations of each process. Such operations may be performed in any of a number of ways, including, without limitation, in the order and manner as depicted and described herein. In some embodiments, one or more blocks of any of the processes described herein occur in-between one or more blocks of another process, before one or more blocks of another process, in parallel with one or more blocks of another process, and/or as a sub-process of a second process. Additionally or alternatively, any of the processes in various embodiments include some or all operational steps described and/or depicted, including one or more optional blocks in some embodiments. With regard to the flowcharts illustrated herein, one or more of the depicted block(s) in some embodiments is/are optional in some, or all, embodiments of the disclosure. Optional blocks are depicted with broken (or “dashed”) lines. Similarly, it should be appreciated that one or more of the operations of each flowchart may be combinable, replaceable, and/or otherwise altered as described herein.

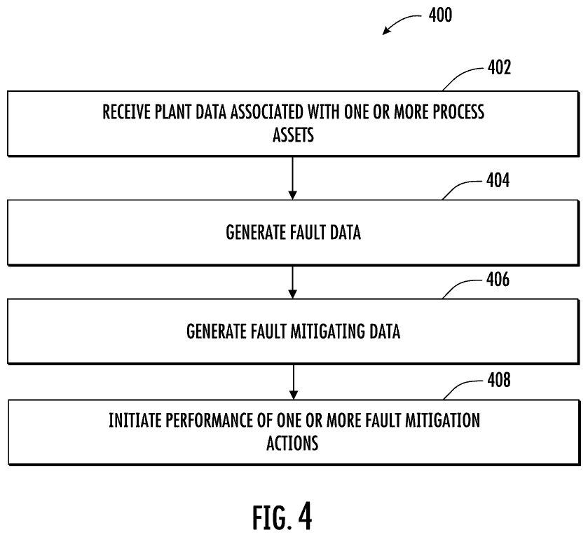

FIG. 4 illustrates a flowchart including operations of an example process for improved asset monitoring and performance visualization in accordance with at least one example embodiment of the present disclosure. In some embodiments, the process/method 400 is embodied by computer program code stored on a non-transitory computer-readable storage medium of a computer program product configured for execution to perform the process as depicted and described. Alternatively or additionally, in some embodiments, the process/method 400 is performed by one or more specially configured computing devices, such as the apparatus 200 alone or in communication with one or more other component(s), device(s), system(s), and/or the like. In this regard, in some such embodiments, the apparatus 200 is specially configured by computer-coded instructions (e.g., computer program instructions) stored thereon, for example in the memory 204 and/or another component depicted and/or described herein and/or otherwise accessible to the apparatus 200, for performing the operations as depicted and described. In some embodiments, the apparatus 200 is in communication with one or more external apparatus(es), system(s), device(s), and/or the like, to perform one or more of the operations as depicted and described. For example, the apparatus 200 in some embodiments is in communication with separate component(s) of a network, external network(s), and/or the like, to perform one or more of the operation(s) as depicted and described. For purposes of simplifying the description, the process/method 400 is described as performed by and from the perspective of the apparatus 200.

Although the example process/method 400 depicts a particular sequence of operations, the sequence may be altered without departing from the scope of the present disclosure. For example, some of the operations depicted may be performed in parallel or in a different sequence that does not materially affect the function of the process/method 400. In other examples, different components of an example device or system that implements the process/method 400 may perform functions at substantially the same time or in a specific sequence.

According to some examples, the process/method 400 includes at operation 402, receiving plant data associated with one or more process assets. For example, the apparatus 200 may receive plant data associated with one or more process assets of a processing plant such as a chemical plant, petrochemical plant, and/or the like. A process asset, for example, may represent a process asset (e.g., one or more equipment) of a plurality of process assets in a processing plant. Non-limiting examples of process assets include compressors, blenders, boilers, reactors, heaters, and/or the like.

In some embodiments, the apparatus 200 receives the plant data from a processing a plant system 104 associated with the processing plant and/or embodying the processing plant. In some embodiments, the plant data comprises measurements such as process measurements collected via one or more sensors and/or process laboratory measurements collected via one or more measuring devices. Such measurements may represent values, ranges, scores, and/or the like for one or more process parameters and/or process parameters with respect to process assets associated with the processing plant.

In some embodiments, the process measurements (e.g., sensor data) from one or more sensors may comprise signals that describe changes with respect to one or more process parameters over a period of time. Example of such process parameters include, but not limited to, composition, feed rate, temperature, pressure, performance metrics, environmental condition (e.g., KPI) and/or the like.

In some embodiments, the plant data 306, include process measurements that describe changes over a time period for one or more process parameters associated with the one or more process assets. For example, process measurements (e.g., raw data and/or signal) from one or more sensors may describe and/or reflect changes over a time period for one or more process parameters associated with the process asset(s). In the context of a chemical process, for example, sensor data from one or more sensors may describe changes over a time period for chemical processing, such as feed rates, changes in ion levels, and configuration modes.

According to some examples, the process/method 400 includes at operation 404 generating fault data based on the plant data. The fault data may comprise one or more detect faults and/or predicted faults indicative of one or more abnormal conditions with a process asset(s). In some embodiments, the apparatus 200 is configured to generate the fault data by applying the plant data to a fault monitoring machine learning model that is configured, trained, and/or the like to identify abnormal conditions associated with a process asset(s).

According to some examples, the process/method 400 includes at operation 406, generating fault mitigating data. For example, the apparatus 200 may be configured to generate fault mitigating data that comprises one or more items of data representative and/or indicative of solutions to minimize impact of a detected and/or predicted fault and/or one or more solutions to resolve a detected fault. In some embodiments, the fault monitoring machine learning model is configured, trained, and/or the like to determine solution(s) to mitigate such potential impact of predicted fault(s) and/or solution(s) to resolve the predicted fault(s).

The fault monitoring machine learning model may be configured to perform what-if-analysis to identify optimal solution to resolve and/or avoid impact of a fault. The fault monitoring machine learning model, for example, may be configured to, for example, via feature contribution and simulation to perform reasoning task, such as what-if-analysis to identify optimal solution as described above. The simulation can be used to perform what-if analysis and find the most optimal solutions to help avoid impact on equipment life, production, or other areas (from purely data driven point of view).

In some embodiments, the fault monitoring machine learning model is a data entity that describes parameters, hyper-parameters, and/or defined operations of a rules-based algorithm, machine learning model (e.g., model including at least one or more rule-based layers, one or more layers that depend on trained parameters, coefficients, and/or the like), and/or artificial intelligence model, and/or the like. The fault monitoring machine learning model may include any type of model configured, trained, and/or the like to perform predictive analysis task on plant data, such as plant data, to detect fault(s) associated with process assets. In this regard, the fault monitoring machine learning model may be configured to utilize one or more of any types of machine learning, rules-based, and/or artificial intelligence techniques including one or more of supervised learning (e.g., using user feedback), unsupervised learning, semi-supervised learning, reinforcement learning, computer vision techniques, sequence modeling techniques, language processing techniques, neural network techniques, and/or generative artificial intelligence techniques.

In some embodiments, the fault monitoring machine learning model defines a fault tree generated based at least in part using first principles model. In this regard, in some embodiments, the fault monitoring machine learning model is a first principles-based fault monitoring machine learning model comprising one or more tree-based algorithms that incorporate first principles knowledge. In particular, the fault monitoring machine learning model may comprise a first principles model and machine learning model integrated together such that the machine learning model may learn, based on the first principles model, events that indicate an abnormal condition.

In some embodiments, the fault tree defined by the fault monitoring machine learning model comprise one or more sets of conditions that if satisfied indicates an abnormal condition. For example, a set of conditions may comprise one or more process parameters and corresponding threshold(s). The fault monitoring machine learning model may be configured to predict the presence of an abnormal condition in response to determining that the relevant portion of the plant data satisfies the one or more process parameters. In some embodiments, the one or more sets of conditions may comprise at least one set of conditions for each of the one or more process assets. In particular, in some embodiments, the fault tree comprises a plurality of sets of conditions representing a logical combination of the set(s) of conditions for each of a plurality of process assets.

According to some examples, the process/method 400 includes at operation 408, initiating the performance of one or more fault mitigation actions. In some embodiments, initiating the performance of one or more fault mitigation actions comprises generating an exception-based alert in response to detecting and/or prediction fault. In some embodiments, a set of conditions define in the fault monitoring machine learning model may be associated with an alert (e.g., exception based alert). The apparatus 200 may be configured, using the fault monitoring machine learning model, to cause an alert to be transmitted in response to determining that the set of condition associated with the alert is satisfied by the plant data (e.g., relevant portion thereof). As described above, a set of conditions or group of sets of conditions may be indicative of deviation from a normal mode of operation of one or more process assets.

### CONCLUSION

Although an example processing system has been described above, implementations of the subject matter and the functional operations described herein can be implemented in other types of digital electronic circuitry, or in computer software, firmware, or hardware, including the structures disclosed in this specification and their structural equivalents, or in combinations of one or more of them.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described herein can be implemented as one or more computer programs, i.e., one or more modules of computer program instructions, encoded on computer storage medium for execution by, or to control the operation of, information/data processing apparatus. Alternatively, or in addition, the program instructions can be encoded on an artificially-generated propagated signal, e.g., a machine-generated electrical, optical, or electromagnetic signal, which is generated to encode information/data for transmission to suitable receiver apparatus for execution by an information/data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described herein can be implemented as operations performed by an information/data processing apparatus on information/data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a repository management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or information/data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described herein can be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory or a random access memory or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, e.g., magnetic, magneto-optical disks, or optical disks. However, a computer need not have such devices. Devices suitable for storing computer program instructions and information/data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described herein can be implemented on a computer having a display device, e.g., a CRT (cathode ray tube) or LCD (liquid crystal display) monitor, for displaying information/data to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described herein can be implemented in a computing system that includes a back-end component, e.g., as an information/data server, or that includes a middleware component, e.g., an application server, or that includes a front-end component, e.g., a client computer having a graphical user interface or a web browser through which a user can interact with an implementation of the subject matter described herein, or any combination of one or more such back-end, middleware, or front-end components. The components of the system can be interconnected by any form or medium of digital information/data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits information/data (e.g., an HTML page) to a client device (e.g., for purposes of displaying information/data to and receiving user input from a user interacting with the client device). Information/data generated at the client device (e.g., a result of the user interaction) can be received from the client device at the server.

While this specification contains many specific implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method comprising:
receiving, by one or more processors, plant data associated with one or more process assets of a process plant;
generating, by the one or more processors, fault data comprising at least one fault with at least one process asset of the one or more process assets based on the plant data and a set of conditions by applying the plant data to a fault monitoring machine learning model configured to: (i) identify from the plant data, one or more process measurements for one or more process parameters, (ii) apply the one or more process measurements to the set of conditions, wherein the set of conditions comprise the one or more process parameters and one or more thresholds for the one or more process parameters, and (iii) generate the fault data indicative of the at least one fault in response to determining that the one or more process measurements satisfy the set of conditions;
generating, by the one or more processors, fault mitigating data for the at least one fault, wherein the fault mitigating data comprises one or more recommendations for minimizing potential impact of the at least one fault; and
initiating, by the one or more processors, performance of one or more fault mitigation actions.

2. The computer-implemented method of claim 1, wherein the one or more process measurements comprise sensor data from one or more sensors associated with the one or more process assets.

3. The computer-implemented method of claim 1, wherein the one or more process measurements comprise laboratory data from one or more measuring devices.

4. The computer-implemented method of claim 1, wherein the fault monitoring machine learning model is a first principles-based machine learning model.

5. The computer-implemented method of claim 4, wherein the fault monitoring machine learning model comprise one of a decision tree algorithm, random forest algorithm, XGBoost algorithm, or CatBoost algorithm.

6. The computer-implemented method of claim 1, further comprising:
retrieving historical plant data from one or more databases;
applying first principles to the historical plant data to generate training data, wherein the training data comprises a plurality of ground truth exception-based alerts; and
training the fault monitoring machine learning model based on the training data and using a tree-based algorithm.

7. The computer-implemented method of claim 1, wherein the fault monitoring machine learning model defines a fault tree, and wherein the set of one or more conditions comprise a portion of the fault tree.

8. The computer-implemented method of claim 1, wherein initiating performance of one or more fault mitigation actions comprises transmitting instructions configured to cause modification of at least one process asset.

9. The computer-implemented method of claim 1, wherein initiating performance of one or more fault mitigation actions comprises providing the fault data for display on a user interface of a client computing entity.

10. The computer-implemented method of claim 1, wherein initiating performance of one or more fault mitigation actions comprises providing the fault mitigating data for display on a user interface of a client computing entity.

11. An apparatus comprising at least one processor and at least one memory storing instructions that, when executed by the at least one processor, cause the apparatus to:
receive plant data associated with one or more process assets of a process plant;
generate fault data comprising at least one fault with at least one process asset of the one or more process assets based on the plant data and a set of conditions by applying the plant data to a fault monitoring machine learning model configured to: (i) identify from the plant data, one or more process measurements for one or more process parameters, (ii) apply the one or more process measurements to the set of conditions, wherein the set of conditions comprise the one or more process parameters and one or more thresholds for the one or more process parameters, and (iii) generate the fault data indicative of the at least one fault in response to determining that the one or more process measurements satisfy the set of conditions;
generate fault mitigating data for the at least one fault, wherein the fault mitigating data comprises one or more recommendations for minimizing potential impact of the at least one fault; and
initiate performance of one or more fault mitigation actions.

12. The apparatus of claim 11, wherein the one or more process measurements comprise sensor data from one or more sensors associated with the one or more process assets.

13. The apparatus of claim 11, wherein the one or more process measurements comprise laboratory data from one or more measuring devices.

14. The apparatus of claim 11, wherein the fault monitoring machine learning model is a first principles-based machine learning model.

15. The apparatus claim 14, wherein the fault monitoring machine learning model comprise one of a decision tree algorithm, random forest algorithm, XGBoost algorithm, or CatBoost algorithm.

16. The apparatus of claim 11, wherein the apparatus is further caused to:
retrieve historical plant data from one or more databases;
apply first principles to the historical plant data to generate training data, wherein the training data comprises a plurality of ground truth exception-based alerts; and
train the fault monitoring machine learning model based on the training data and using a tree-based algorithm.

17. The apparatus of claim 11, wherein the fault monitoring machine learning model defines a fault tree, and wherein the set of one or more conditions comprise a portion of the fault tree.

18. The apparatus of claim 11, wherein initiating performance of one or more fault mitigation actions comprises transmitting instructions configured to cause modification of at least one process asset.

19. The apparatus of claim 11, wherein initiating performance of one or more fault mitigation actions comprises providing the fault data for display on a user interface of a client computing entity.

20. At least one non-transitory computer-readable storage medium having computer coded instructions configured to, when executed by at least one processor:
receive plant data associated with one or more process assets of a process plant;
generate fault data comprising at least one fault with at least one process asset of the one or more process assets based on the plant data and a set of conditions by applying the plant data to a fault monitoring machine learning model configured to: (i) identify from the plant data, one or more process measurements for one or more process parameters, (ii) apply the one or more process measurements to the set of conditions, wherein the set of conditions comprise the one or more process parameters and one or more thresholds for the one or more process parameters, and (iii) generate the fault data indicative of the at least one fault in response to determining that the one or more process measurements satisfy the set of conditions;
generate fault mitigating data for the at least one fault, wherein the fault mitigating data comprises one or more recommendations for minimizing potential impact of the at least one fault; and
initiate performance of one or more fault mitigation actions.
